(19) United States
(12) Patent Application Publication
(10) Pub. No.: US 2018/0237545 A1
(43) Pub. Date: Aug. 23, 2018

(54) CELLULOSE FIBER AND METHOD FOR PRODUCING CELLULOSE FIBER

(71) Applicant: Seiko Epson Corporation, Tokyo (JP)

(72) Inventor: Makoto KATO, Suwa (JP)

(21) Appl. No.: 15/856,413

(22) Filed: Dec. 28, 2017

(30) Foreign Application Priority Data
Feb. 23, 2017 (JP) 2017-031826

(51) Int. Cl. C08B 15/05; D21H 11/20; D21C 9/00

(52) U.S. Cl. CPC C08B 15/05; D21C 9/005; D21C 9/004; D21H 11/20

(57) ABSTRACT

A cellulose fiber according to the invention is a cellulose fiber in which hydroxy groups of cellulose represented by the following formula (1) are substituted with a boronate ester group represented by the following formula (2), and includes at least one of: a type 1 structure in which hydroxy groups of at least one of the unit structures a and b of the same cellulose molecular chain n of the cellulose are substituted with the boronate ester group; a type 2 structure in which hydroxy groups of both unit structures a and b of the same cellulose molecular chain n of the cellulose are substituted with the boronate ester group; and a type 3 structure in which hydroxy groups of different cellulose molecular chains n of the cellulose are substituted with the boronate ester group, wherein carbon to which the hydroxy groups to be substituted with the boronate ester group are bonded is two carbon atoms selected from the carbon atoms at positions 2, 3, and 6 of the unit structures a and b.

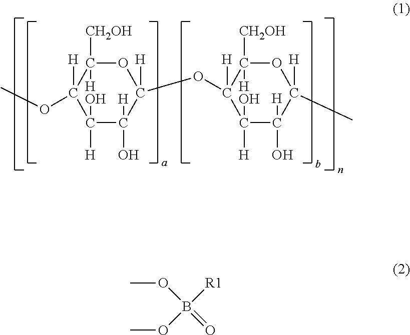

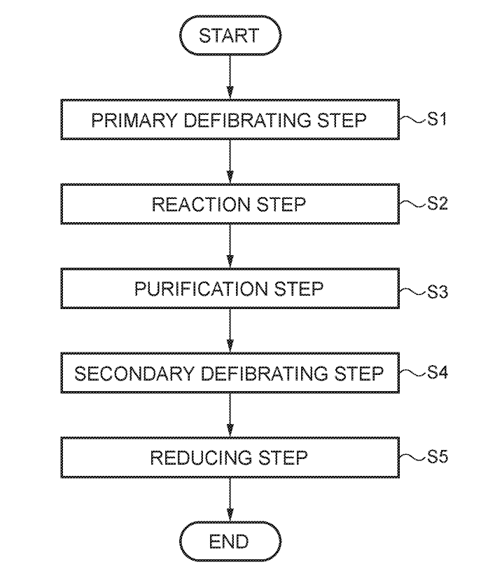

### BACKGROUND

### 1. Technical Field

The present invention relates to a cellulose fiber and a method for producing a cellulose fiber.

### 2. Related Art

A cellulose nanofiber as a cellulose fiber is a material which has been gaining rapid popularity in recent years from the viewpoint of light weight, high strength, low thermal expansion, and ecology. As a method for producing a cellulose nanofiber, for example, physical defibration in which pulp or the like is physically finely defibrated, and chemical defibration in which pulp or the like is defibrated by chemical modification can be exemplified. As the latter chemical defibration method, for example, JP-A-2009-243014 (Patent Document 1) discloses a method for producing a cellulose nanofiber capable of easily performing defibration by modifying a primary hydroxy group of a cellulose-based raw material with a carboxyl group using a TEMPO (2,2,6,6-tetramethyl-1-piperidine-N-oxyradical) catalyst and a bromide, an iodide, or a mixture thereof, and an oxidizing agent.

However, in the production method disclosed in Patent Document 1, electrostatic repulsion occurs due to the modification of some hydroxy groups of a cellulose nanofiber with a carboxyl group, and therefore, the strength between the cellulose nanofibers is decreased. Therefore, in order to further increase the strength of a molded material using a cellulose nanofiber, it is demanded that the electrostatic repulsion be decreased by reducing the primary hydroxy group modified with a carboxyl group by oxidation of TEMPO to the original hydroxy group. On the other hand, in order to reduce the carboxyl group, it is necessary to perform a treatment at a high temperature for a long time using a strong reducing agent. As an example of the reducing agent, lithium tetrahydridoaluminate (LiAlH₄) which violently reacts with water to generate hydrogen, borane (BH₃) which has high toxicity, or the like is used. Therefore, the method has a problem that it is not easy to reduce the carboxyl group to a hydroxy group.

Further, in the production method disclosed in Patent Document 1, it is described that a bromide, an iodide, and an oxidizing agent are used, and an example in which sodium bromide is used as the bromide, sodium iodide is used as the iodide, and sodium chlorite is used as the oxidizing agent is exemplified. Due to this, in the cellulose nanofiber obtained by the method disclosed in Patent Document 1, an alkali metal typified by sodium or an alkaline earth metal is contained. Therefore, when using the cellulose nanofiber, it is necessary to perform a treatment of removing such an alkali metal or an alkaline earth metal in some cases. However, there is a problem that such a treatment is not easy.

### SUMMARY

An advantage of some aspects of the invention is to solve at least part of the problems described above and the invention can be implemented as the following forms or application examples.

### Application Example 1

A cellulose fiber according to this application example is a cellulose fiber in which hydroxy groups of cellulose represented by the following formula (1) are substituted with a boronate ester group represented by the following formula (2), and includes at least one of: a type 1 structure in which hydroxy groups of at least one of the unit structures a and b of the same cellulose molecular chain n of the cellulose are substituted with the boronate ester group; a type 2 structure in which hydroxy groups of both unit structures a and b of the same cellulose molecular chain n of the cellulose are substituted with the boronate ester group; and a type 3 structure in which hydroxy groups of different cellulose molecular chains n of the cellulose are substituted with the boronate ester group, wherein carbon to which the hydroxy groups to be substituted with the boronate ester group are bonded is two carbon atoms selected from the carbon atoms at positions 2, 3, and 6 of the unit structures a and b.

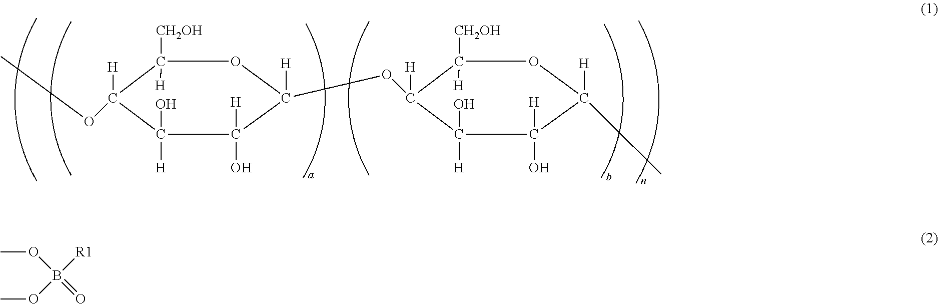

According to this application example, the boronate ester group bonded to at least two carbon atoms of the cellulose represented by the above formula (1) exhibits electrostatic repulsion, and therefore, a cellulose fiber which can be easily chemically defibrated by a simple operation of only adjusting the pH of the solution containing the cellulose fiber can be provided. Further, the boronate ester group can be returned to the original hydroxy group by reducing the cellulose to which the boronate ester group is bonded by a simple operation of only adjusting the pH of the solution containing the cellulose fiber after defibration. That is, the cellulose fiber in which electrostatic repulsion is reduced can be provided.

### Application Example 2

In the cellulose fiber according to the application example, it is preferred that R1 of the boronate ester group is a phenyl group.

According to this application example, since the phenyl group has high hydrophobicity, large electrostatic repulsion can be obtained. That is, a finer defibrated state can be efficiently realized.

### Application Example 3

A method for producing a cellulose fiber according to this application example includes performing an esterification reaction of cellulose using a reaction solution which has a neutral to alkaline pH and contains a composition containing the cellulose, a boronic acid compound, and a solvent.

According to this application example, the cellulose fiber obtained by esterification of the composition containing the cellulose using the boronic acid compound can be easily chemically defibrated by only adjusting the pH of the solution containing the cellulose fiber. Further, the esterification reaction proceeds mildly by only adjusting the pH of the reaction solution without using an oxidizing agent, an oxidation catalyst, or the like in the reaction solution in the reaction step, and therefore, the defibration operation can be performed safely.

### Application Example 4

In the method for producing a cellulose fiber according to the application example, it is preferred that the boronic acid compound is phenylboronic acid.

According to this application example, phenylboronic acid is dissolved in water or an alcohol which is a dispersion medium of the cellulose, and also has a phenyl group having large electrostatic repulsion so as to have a high effect of decreasing the energy necessary for defibration, and therefore is suitable as the boronic acid compound to be mixed in the reaction solution.

### Application Example 5

In the method for producing a cellulose fiber according to the application example, it is preferred that the reaction solution contains an organic alkali which does not contain a metal element.

According to this application example, by using an organic alkali which does not contain a metal element, the removal of an impurity or an unreacted material contained in the reaction solution after the reaction step is simplified, and therefore can be performed in a short time at low cost.

### Application Example 6

In the method for producing a cellulose fiber according to the application example, it is preferred that the reaction solution contains an electron donating substance.

According to this application example, by adding an electron donating substance, an electron enters the unoccupied orbital of boron of the boronic acid compound to apply a charge bias to boron, and therefore, the reaction step can be allowed to proceed under neutral to weakly alkaline conditions, and thus, the reaction step can be relatively safely performed and also the time of the reaction step can be reduced. Further, the reaction solution has a neutral pH, and therefore, when the reaction solution is made acidic in the subsequent reducing step, the reaction solution can be made acidic with a pH adjusting agent in a small addition amount, and therefore, it is economical.

### Application Example 7

In the method for producing a cellulose fiber according to the application example, it is preferred that the electron donating substance is dimethylethylamine.

According to this application example, dimethylethylamine can be dissolved in an aprotic polar solvent, water, and an alcohol, and therefore is one of the organic solvents capable of applying a charge bias to boron by being added to the reaction solution, and thus can reduce the time of the reaction step.

### Application Example 8

In the method for producing a cellulose fiber according to the application example, it is preferred that the electron donating substance is contained in the reaction solution when the reaction solution has a pH of 7 or more.

According to this application example, by adjusting the pH of the reaction solution to a neutral to alkaline pH of 7 or more, the reaction of the modifying step of modifying the carbon atoms at positions 2, 3, and 6 of the cellulose with the boronic acid compound proceeds, and a finer defibrated state can be efficiently realized. Further, by adding the electron donating substance, the modification of the cellulose with the boronic acid compound can be efficiently performed.

### Application Example 9

In the method for producing a cellulose fiber according to the application example, it is preferred that the electron donating substance is not contained in the reaction solution when the reaction solution has a pH of 8.5 or more.

According to this application example, when the reaction solution has a pH of 8.5 or more, the boronic acid compound in the alkaline reaction solution is in a dissociated state, and therefore, an electron donating substance that assists in putting the compound in a dissociated state is not needed, and therefore, the modification of the cellulose with the boronic acid compound can be efficiently performed with a few materials.

### Application Example 10

In the method for producing a cellulose fiber according to the application example, it is preferred that the method includes a purification step of removing an unreacted material after the reaction step.

According to this application example, since the reaction of modification of the carbon atoms at positions 2, 3, and 6 of the cellulose with the boronic acid compound is an equilibrium reaction, it is very difficult to obtain a yield of 100% and an unreacted boronic acid compound remains, and by removing the remaining unreacted boronic acid compound, the purity and the strength of a molded product using the cellulose fiber can be further increased.

### Application Example 11

In the method for producing a cellulose fiber according to the application example, it is preferred that the method includes a defibrating step of defibrating the composition containing cellulose in advance before the reaction step.

According to this application example, the composition containing cellulose is made finer so as to increase the specific surface area by the defibrating step, and therefore, the frequency of collision thereof with the reaction solution is increased, and thus, the time of the reaction step can be reduced.

### Application Example 12

In the method for producing a cellulose fiber according to the application example, it is preferred that the method includes a defibrating step of defibrating the composition containing cellulose after the reaction step.

According to this application example, the specific surface area of the obtained cellulose fiber after the reaction step is increased by the defibrating step, and therefore, the transparency, the strength, and the like of a dispersion liquid, a film, or a molded product to be formed thereafter can be increased.

### Application Example 13

In the method for producing a cellulose fiber according to the application example, it is preferred that the method includes a primary defibrating step of defibrating the composition containing cellulose in advance before the reaction step and a secondary defibrating step which is performed after the purification step.

According to this application example, the specific surface area of the composition containing cellulose before the reaction step is increased by the primary defibrating step, so that the frequency of collision thereof with the reaction solution is increased, and therefore, the time of the reaction step can be reduced. In the secondary defibrating step, the specific surface area of the cellulose fiber obtained after the reaction step is increased, and therefore, the transparency, the strength, and the like of a dispersion liquid, a film, or a molded product to be formed thereafter can be increased.

### Application Example 14

In the method for producing a cellulose fiber according to the application example, it is preferred that the method further includes a reducing step of reducing the cellulose modified with the boronic acid compound in the reaction step so as to convert the modifying group into a hydroxy group.

According to this application example, the modifying group which causes electrostatic repulsion is reduced and returned to the hydroxy group so as to eliminate the electrostatic repulsion, and therefore, the intermolecular force of the cellulose fibers becomes strong, and the strength of a film or a molded product can be further increased.

### Application Example 15

In the method for producing a cellulose fiber according to the application example, it is preferred that in the reducing step, the pH of the reaction solution after the reaction step or after the purification step is adjusted to less than 7.

According to this application example, by adjusting the pH of the reaction solution containing the cellulose fiber modified with the boronic acid compound to less than 7, the modifying group is easily reduced to a hydroxy group so as to be able to perform decomposition into the cellulose fiber modified with the hydroxy group and the boronic acid compound. Therefore, the reducing step is performed by the very mild reaction in which the pH is adjusted to less than 7, and the cellulose fiber modified with the hydroxy group can be produced.

### Application Example 16

In the method for producing a cellulose fiber according to the application example, it is preferred that in the reducing step, an organic acid which does not contain a metal element is added to the reaction solution after the reaction step or after the purification step.

According to this application example, by using an organic acid which does not contain a metal element, the removal of an impurity or an unreacted material contained in the reaction solution after the reaction step is simplified, and therefore can be performed in a short time at low cost.

### Application Example 17

In the method for producing a cellulose fiber according to the application example, it is preferred that the organic acid is acetic acid.

According to this application example, the cost can be reduced by using an inexpensive chemical product.

### BRIEF DESCRIPTION OF THE DRAWINGS

The invention will be described with reference to the accompanying drawings, wherein like numbers reference like elements.

The FIGURE is a flow diagram showing a method for producing a cellulose fiber according to a second embodiment.

### DESCRIPTION OF EXEMPLARY EMBODIMENTS

Hereinafter, embodiments of the invention will be described with reference to the drawings. Incidentally, in the following respective drawings, in order to make the size of a molecule, an intermolecular distance, the length of a connector, and the direction of a connector recognizable, the molecular structural formulae are made different from the actual ones.

### First Embodiment

### Cellulose

First, the molecular structure of cellulose will be described.

In the method for producing a cellulose fiber which will be described later, cellulose contained in a composition to serve as a raw material is represented by the following formula (1). Cellulose is a polymer, which includes β-glucose as unit structures a and b, and in which these structures are linked through a glycosidic bond. The cellulose fiber according to this embodiment is a cellulose fiber in which hydroxy groups of the cellulose represented by the following formula (1) are substituted with a boronate ester group represented by the following formula (2).

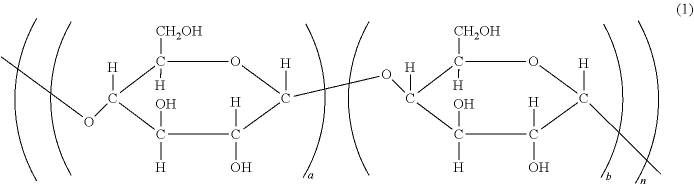

### Boronic Acid Compound

A boronic acid compound containing a boronate ester group represented by the following formula (2) is a boronic acid compound, which has a molecular weight of 300 or less, and in which a functional group R1 contains at least one member selected from an alkyl, a cyclic alkyl, an aromatic ring, an amide, an ester, an amine, an ether, a cyclic ether, an amine, a cyclic amine, a thiol, a thioether, and a halogen. The boronic acid compound is preferably a compound which can be dissolved in water and an alcohol. Further, in order to reduce the electrostatic repulsion, the boronic acid compound preferably has high hydrophobicity and is preferably phenylboronic acid in which the functional group of boronic acid is a phenyl group.

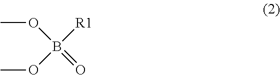

### Cellulose Fiber

Examples of the molecular structure of the cellulose fiber in which hydroxy groups are substituted with the boronate ester group are shown in the following formulae (3) to (5). In this specification, substitution of hydroxy groups of the cellulose represented by the above formula (1) with the boronate ester group of a boronic acid compound refers to modification of hydroxy groups of the cellulose with a boronic acid compound. That is, the cellulose fiber according to this embodiment is a cellulose fiber in which hydroxy groups of the cellulose are modified with a boronic acid compound.

Cellulose Fiber being Type 1 Structure in which Hydroxy Groups of the Same Unit Structure of the Same Cellulose Molecular Chain are Substituted with Boronate Ester Group

The following formula (3) represents a structure in which two hydroxy groups among the three hydroxy groups present in the same unit structure a of the same cellulose molecular chain n are substituted with the boronate ester group. In the following formula (3), the hydroxy groups bonded to the carbon atoms at positions 2 and 3 of the unit structure a are substituted with the boronate ester group, however, the hydroxy groups bonded to the carbon atoms at positions 2 and 6, and at positions 3 and 6 can be substituted with the boronate ester group. Further, two hydroxy groups among the three hydroxy groups present in the unit structure b may be substituted with the boronate ester group.

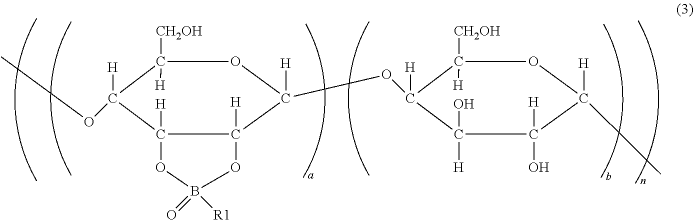

Cellulose Fiber being Type 2 Structure in which Hydroxy Groups of Different Unit Structures of the Same Cellulose Molecular Chain are Substituted with Boronate Ester Group

The following formula (4) represents a structure in which hydroxy groups of different unit structures a and b of the same cellulose molecular chain n are substituted with the boronate ester group. In the following formula (4), the hydroxy group bonded to the carbon atom at position 3 of the a-th unit structure and the hydroxy group bonded to the carbon atom at position 2 of the b-th unit structure are substituted with the boronate ester group, however, the substitution can be performed even if the a-th unit structure and the b-th unit structure are adjacent to each other or separated from each other. Further, as for the position of the carbon atom to which the hydroxy group to be substituted is bonded, the hydroxy group at any position of the positions 2, 3, and 6 can be substituted.

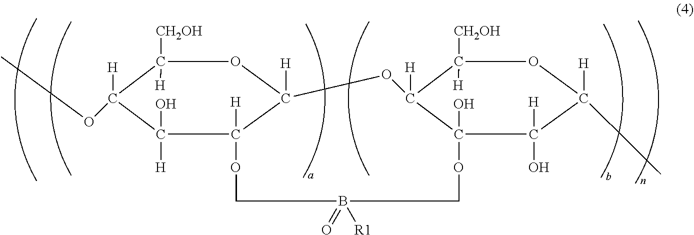

Cellulose Fiber being Type 3 Structure in which Hydroxy Groups of Different Cellulose Molecular Chains are Substituted with Boronate Ester Group

The following formula (5) represents a structure in which hydroxy groups of unit structures a and b of different cellulose molecular chains are substituted with the boronate ester group. In the following formula (5), the subscripts x and y denote different cellulose molecular chains. As for the position of the carbon atom to which the hydroxy group to be substituted is bonded, the hydroxy group at any position of the positions 2, 3, and 6 can be substituted. Further, in the following formula (5), an example in which the hydroxy group of the unit structure a of the cellulose molecular chain x and the hydroxy group of the unit structure a of the cellulose molecular chain y are substituted with the boronate ester group is shown, however, structures in which hydroxy groups of the different unit structures a and b in the different cellulose molecular chains x and y are substituted with the boronate ester group are also included.

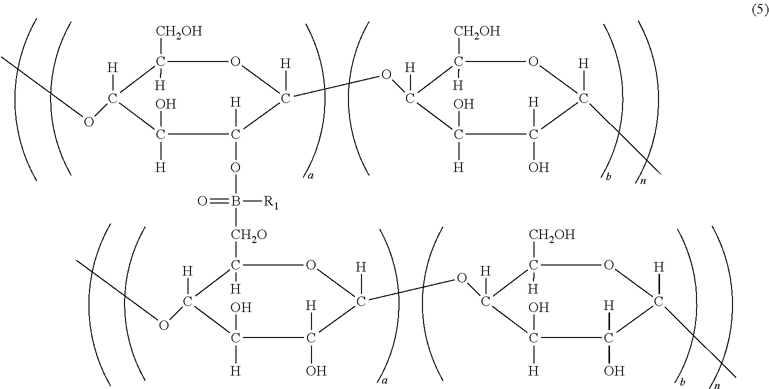

Composition of Cellulose Fiber in which Hydroxy Groups are Substituted with Boronate Ester Group

The cellulose fiber in which hydroxy groups are substituted with the boronate ester group as shown in the above formulae (3) to (5) can be constituted by any one type or a mixture of a plurality of types of the formulae (3) to (5).

The cellulose fiber according to this embodiment includes at least one of the type 1 structure to the type 3 structure represented by the above formulae (3) to (5), and is a cellulose fiber in which two-thirds or less of the hydroxy groups of the cellulose contained in the composition which is a raw material are substituted with the boronate ester group. Further, the cellulose fiber preferably does not contain alkali metals, alkaline earth metals, lanthanoids, actinoids, transition metals, metalloid elements, and other metal elements in the periodic table, and preferably does not contain at least metal elements in Groups 1 to 12. A method producing such a cellulose fiber will be described later.

As described above, by the cellulose fiber according to this embodiment, the following effects can be obtained.

(1) In the cellulose fiber in which hydroxy groups of the cellulose are modified with a boronic acid compound so as to include the boronate ester group, the boronate ester group can be easily returned to the original hydroxy group by adjusting the pH of the solution containing the cellulose fiber to an acidic pH of less than 7 to effect reduction, and therefore, the bond between the cellulose fibers can be made strong, and thus, the strength of a molded material using the cellulose fiber can be further increased.

(2) Two-thirds or less of the hydroxy groups contained in the cellulose are modified with a boronic acid compound, and therefore, electrostatic repulsion occurs between cellulose molecular chains, and thus, acquisition of a finer cellulose fiber can be effectively realized.

### Second Embodiment

Next, a method for producing a cellulose fiber according to this embodiment will be described with reference to the FIGURE. The FIGURE is a flow diagram showing the method for producing a cellulose fiber according to the second embodiment.

As shown in the FIGURE, the method for producing a cellulose fiber according to this embodiment includes a primary defibrating step (Step S1) of defibrating a composition containing cellulose in advance, a reaction step (Step S2) of performing an esterification reaction of cellulose using a reaction solution which contains the composition containing the cellulose, a boronic acid compound, and a solvent by adjusting the pH of the reaction solution to a neutral to alkaline pH, a purification step (Step S3) of removing an unreacted material, a secondary defibrating step (Step S4), and a reducing step (Step S5) of reducing the cellulose modified (esterified) with the boronic acid compound in the reaction step so as to convert the modifying group (boronate ester group) into a hydroxy group.

### Composition Containing Cellulose

Examples of the composition containing cellulose which is a raw material include pulp obtained by pulping a wood material, a plant, a seaweed, or the like, and waste paper pulp obtained by recycling waste paper. Here, in order to efficiently obtain a cellulose fiber, pulp is used. Examples of the pulp include wood pulp obtained by pulping a broadleaf tree or a conifer tree, and non-wood pulp derived from linter, kenaf, bagasse, bamboo, or the like, however, wood pulp with which a cellulose fiber is most stably obtained is used. Examples of a method for producing wood pulp include mechanical pulping and chemical pulping, however, in order to allow the respective steps shown in the FIGURE to proceed efficiently, chemical pulping capable of achieving a high cellulose purity is used. Examples of the pulp include unbleached pulp and bleached pulp which are grouped according to with or without bleaching step, however, in order to allow the respective steps to proceed efficiently, chemically bleached pulp is used. The composition containing cellulose as a raw material is not limited to the above-mentioned materials. Further, the method for producing the pulp, the method for the bleaching step, and the like are not limited to above-mentioned methods.

### Primary Defibrating Step

The primary defibrating step of Step S1 shown in the FIGURE is performed for allowing the subsequent reaction step to proceed efficiently, and can also be omitted. In the primary defibrating step, a compression force, a shear force, an impact force, or a grinding force is applied, and fine grinding of the composition containing cellulose as a starting raw material using any of wet grinding, dry grinding, and freeze grinding and dispersion thereof in water are simultaneously performed. In this embodiment, chemically bleached pulp is used as the composition containing cellulose which is a starting raw material, and the chemically bleached pulp has been defibrated into a fiber with a diameter of about several tens of micrometers and a length of about several hundreds of micrometers to several millimeters, and therefore, in the primary defibrating step, in order to allow the subsequent reaction step to proceed efficiently, the chemically bleached pulp is dispersed in water using a wet grinding method. In the wet grinding method, a cuter mill is adopted. In the cutter mill, the chemically bleached pulp and water in an amount of 900 wt % with respect to the chemically bleached pulp are placed, and a treatment is performed for 10 minutes. An aqueous dispersion liquid of the chemically bleached pulp at this time is a white cloudy liquid with a low viscosity. In the primary defibrating step, the composition containing cellulose to be used as a raw material in a state before the reaction step is preferably defibrated into a fiber with a diameter of about 1 μm to 500 μm and a length of about several tens of micrometers to several hundreds of micrometers and also dispersed in a solvent.

Examples of the solvent to be used for dispersing the composition containing cellulose include water and organic solvents soluble in water, for example, monohydric alcohols having 1 to 4 carbon atoms such as methanol, ethanol, 1-propanol, 2-propanol, 1-butanol, and 2-butanol, dihydric alcohols having 1 to 4 carbon atoms typified by ethylene glycol, propane glycol, and butanediol, dihydric alcohols having an ether bond typified by diethylene glycol and dipropylene glycol, trihydric alcohols having 1 to 6 carbon atoms typified by glycerin, and aprotic polar solvents typified by dimethylformamide, dimethylacetamide, and dimethyl sulfoxide.

### Reaction Step

In the reaction step of Step S2 shown in the FIGURE, a reaction in which cellulose contained in the composition is modified with a boronic acid compound is performed. With respect to the cellulose of the chemically bleached pulp dispersed in water after being subjected to the primary defibrating step, a boronic acid compound in an amount of 74 wt % and a solvent in an amount of 900 wt % were added, and the pH of this solution is adjusted to a neutral to alkaline pH, and the resulting solution is used as the reaction solution. The reaction solution is stirred at normal temperature for 12 hours, whereby the reaction in which cellulose is esterified and modified with the boronic acid compound is performed. The boronic acid compound is the boronic acid compound represented by the chemical formula (2) in the above-mentioned first embodiment, and phenylboronic acid in which a functional group represented by R1 is a phenyl group is used. As the solvent, one solvent or a mixed solution of two or more solvents selected from the solvents to be used for dispersing the composition containing cellulose described for the primary defibrating step can be used, however, here, ethanol is used. In the case of using a pH adjusting agent in order to adjust the pH of the reaction solution, as the pH adjusting agent, an organic alkali which does not contain a metal element is used. Examples of the organic alkali include trimethylammonium hydroxide, trimethylamine, and aniline, however, here, trimethylammonium hydroxide is used. The reaction solution can be heated as needed during stirring. Further, a pH adjusting agent can be added thereto so that the reaction solution is not acidic during the reaction step. The reaction solution after the reaction step is a white cloudy liquid. At this time point, the cellulose of the chemically bleached pulp has a molecular structure represented by any of the above formulae (3) to (5).

### Purification Step

In the purification step of Step S3 shown in the FIGURE, the unreacted boronic acid compound remaining after the reaction step is removed. First, the reaction solution is filtered to separate the cellulose modified with phenylboronic acid from the liquid containing unreacted phenylboronic acid. The cellulose modified with phenylboronic acid remaining after the filtration is washed with a mixed liquid containing a solvent at a pH of 8.5 or more and the above-mentioned pH adjusting agent as a washing liquid. As the washing method, filtration, centrifugation, liquid separation, and the like can be exemplified, however, here, centrifugation was performed 5 times. As the solvent to be used in the washing liquid, a solvent to be used for dispersing the composition containing cellulose described for the primary defibrating step can be used as long as it has a pH of 8.5 or more, however, here, a mixed solution containing a mixed liquid obtained by mixing water and ethanol at a weight ratio of 1:1, which is the same solvent as used in the reaction solution in the primary defibrating step and the reaction step, and trimethylammonium hydroxide which is used as a pH adjusting agent to adjust the pH to 8.5 or more is used. After performing centrifugation 5 times, the cellulose modified with phenylboronic acid is dispersed in the washing liquid.

### Secondary Defibrating Step

In the secondary defibrating step of Step S4 shown in the FIGURE, defibration is performed again for defibrating the cellulose modified with phenylboronic acid obtained by the purification step into a finer fiber. The secondary defibrating step may be omitted as needed. Further, in the flow shown in the FIGURE, the order of the secondary defibrating step can be changed as long as the secondary defibrating step is performed between steps after the reaction step and before the reducing step. In the secondary defibrating step, a grinding method exemplified for the primary defibrating step can be used. Here, a cutter milling method is adopted in the same manner as in the primary defibrating step. In the cutter mill, the cellulose modified with phenylboronic acid dispersed in the washing liquid after being subjected to the purification step is placed, and a treatment is performed for 30 minutes. The liquid of the cellulose modified with phenylboronic acid dispersed in the washing liquid becomes a transparent liquid.

### Reducing Step

The reducing step of Step S5 shown in the FIGURE is a step of reducing the cellulose modified with phenylboronic acid to return the modifying group (boronate ester group) to the original hydroxy group. In the reducing step, while stirring the cellulose modified with phenylboronic acid dispersed in the washing liquid, the pH of the solution containing the washing liquid and the cellulose is adjusted to less than 7, and stirring is performed for 1 hour. Examples of the pH adjusting agent to be used for adjusting the pH of the solution to less than 7 include organic acids which do not contain a metal such as formic acid, acetic acid, propionic acid, butyric acid, isobutyric acid, valeric acid, isovaleric acid, caproic acid, enanthic acid, caprylic acid, lauric acid, myristic acid, oleic acid, linoleic acid, linolenic acid, salicylic acid, gallic acid, benzoic acid, phthalic acid, cinnamic acid, oxalic acid, lactic acid, maleic acid, tartaric acid, fumaric acid, malonic acid, succinic acid, malic acid, citric acid, glutaric acid, adipic acid, and ascorbic acid, however, here, acetic acid is used. During the stirring in the reducing step, the pH of the solution is maintained at less than 7 by adding acetic acid as the pH adjusting agent as needed while constantly monitoring the pH of the solution. After completion of stirring, the cellulose fiber is collected by filtration, and the collected cellulose fiber is washed with a solvent. As the solvent here, one solvent or a mixed solution of two or more solvents selected from the solvents described for the primary defibrating step can be used, however, here, a mixed solution obtained by mixing water and ethanol at a weight ratio of 1:1 is used. As the washing method, filtration, centrifugation, liquid separation, and the like can be exemplified, however, here, a treatment is performed by performing centrifugation 5 times, and thereafter, the cellulose fiber is dispersed in water. An aqueous dispersion liquid of the cellulose fiber is transparent.

As described above, with the use of the method for producing a cellulose fiber according to this embodiment, a cellulose fiber including at least one of the type 1 structure to the type 3 structure represented by the above formulae (3) to (5) shown in the above first embodiment can be efficiently obtained.

First, by modifying the cellulose with phenylboronic acid, electrostatic repulsion occurs between cellulose molecules, and the strength between the cellulose molecules is decreased, and therefore, the secondary defibrating step is easily performed.

Further, in the cellulose modified with phenylboronic acid, the phenylboronic acid used for modification can be easily detached by only adjusting the pH, and therefore, by adjusting the pH of the solution containing the cellulose modified with phenylboronic acid to an acidic pH in the reducing step, the modifying group can be reduced to a hydroxy group. When the cellulose fiber is modified with phenylboronic acid, electrostatic repulsion occurs between the cellulose fibers, and the bonding strength between the cellulose fibers is decreased, and therefore, it is difficult to increase the mechanical strength of a molded material using the cellulose fiber. Accordingly, by reducing the hydroxy group modified with the phenylboronic acid to the original hydroxy group in the reducing step, the electrostatic repulsion between the cellulose fibers is decreased so as to increase the bonding strength between the cellulose fibers, and the mechanical strength of a molded material using the reduced cellulose fiber can be further increased.

In the above production process, a composition containing a metal and a solvent containing a metal are not used, and therefore, an impurity removing step for removing the metal, specifically, ion exchange, neutral aggregation, etc. are not needed, and thus, the cost for the production process can be further reduced. Further, the obtained cellulose fiber does not contain a metal element such as an alkali metal or an alkaline earth metal which causes malfunction of an electronic device, and therefore can be favorably used as a structural member of an electronic device.

It is difficult to completely reduce all the phenylboronic acid molecules used for modification in the reducing step, and therefore, in the cellulose fiber obtained after the reducing step, at least one of the cellulose fibers of the type 1 structure to the type 3 structure represented by the above formulae (3) to (5), and the original cellulose before modification represented by the above formula (1) may sometimes coexist together.

The method for producing a cellulose fiber according to the above second embodiment is not limited to the flow order of the steps from Step S1 to Step S5 shown in the FIGURE. The primary defibrating step of Step S1 can be omitted when the composition containing cellulose as a raw material is in a state where the diameter of the fiber is about several tens of micrometers and the length thereof is about several hundreds of micrometers to several millimeters before performing Step S1. Further, the primary defibrating step of Step S1 can be omitted by extending the reaction time in the reaction step even if the size of the fiber is larger than the above-mentioned size. Further, the order of the secondary defibrating step of Step S4 can be replaced as long as the secondary defibrating step is performed between the reaction step and the reducing step.

### Third Embodiment

### Method for Producing Cellulose Fiber

Next, a method for producing a cellulose fiber according to a third embodiment will be described. In the method for producing a cellulose fiber according to the third embodiment, the conditions for the reaction step (Step S2) are made different from those of the method for producing a cellulose fiber according to the second embodiment described above. Therefore, the reaction step of the third embodiment will be described, and the steps other than the reaction step are the same as in the above-mentioned second embodiment, and therefore, a detailed description thereof will be omitted.

In the reaction step of this embodiment, a reaction solution obtained by adding phenylboronic acid as a boronic acid compound, ethanol as a solvent, and dimethylethylamine as a reaction aid (electron donating substance) to the composition containing cellulose after being subjected to the primary defibrating step, and adding tetramethylammonium hydroxide or acetic acid as a pH adjusting agent thereto so as to adjust the pH of this mixture to 7 or more is stirred for 12 hours. Examples of the reaction aid (electron donating substance) include, other than dimethylethylamine, diethylmethylamine, trimethylamine, triethylamine, morpholine, N-methylmorpholine, N-ethylmorpholine, piperazine, hydroxyethylpiperazine, N-ethylethanolamine, N-ethyldiethanolamine, N-n-butylethanolamine, N-n-butyldiethanolamine, N-t-butyldiethanolamine, N,N-diethylisopropanolamine, N,N-dimethylethanolamine, N,N-diethylethanolamine, N,N-dibutylethanolamine, N-methylethanolamine, N-methyldiethanolamine, pyridine, hydroxymethylpyridine, 2-vinylpyridine, 4-hydroxypyridine, 4-methoxypyridine, indole, carbazole, and piperidine. The reaction aid is not particularly limited as long as it is an organic compound which has an electron donating property, can be dissolved in water and an alcohol, and does not contain a metal element.

As described above, with the use of the method for producing a cellulose fiber according to this embodiment, in addition to the effects of the above-mentioned second embodiment, the following effect can be obtained.

By adding the reaction aid (electron donating substance) to the reaction solution, even if the reaction solution is in a neutral pH state, the cellulose contained in the composition can be modified (esterified) with phenylboronic acid. The reaction solution in the reaction step has a neutral pH, and therefore, the safety of the operation is increased. Further, the solution in which the cellulose fiber is dispersed can be easily made acidic in the reducing step.

Next, more specific Examples and Comparative Examples of the methods for producing a cellulose fiber according to the above-mentioned second and third embodiments will be shown and the evaluation results of Examples will be described.

### Example 1

### Production of Cellulose Fiber

As a starting raw material, bleached kraft pulp (KP) is used. The KP is dispersed in water, and the primary defibrating step is performed for 10 minutes using a juicer mixer. A solution obtained by adding phenylboronic acid, ethanol, and water to an aqueous dispersion liquid of the KP subjected to the primary defibrating step, and adjusting the pH of this mixture to 8.5 or more with tetramethylammonium hydroxide is used as the reaction solution in the reaction step, and the reaction solution is stirred at normal temperature for 12 hours. During the stirring, the pH of the solution is constantly monitored with a pH meter, and tetramethylammonium hydroxide is added so as to maintain the pH at 8.5 or more. The composition of the reaction solution is shown in Table 1. After completion of stirring, in order to remove the unreacted phenylboronic acid, filtration is performed. Simultaneously with filtration, a mixed solution of ethanol, water, and tetramethylammonium hydroxide at a compositional ratio shown in Table 1 is used as a washing liquid, the washing liquid in the same amount as that of the reaction solution is allowed to pass therethrough 5 times, and the cellulose fiber modified with phenylboronic acid remaining after the filtration is collected and dispersed in the washing liquid. The concentration of the cellulose fiber to be dispersed is set to 0.5 wt % with respect to the dispersion liquid. The dispersion liquid of the cellulose fiber modified with phenylboronic acid in the washing liquid is subjected to the secondary defibrating step using a juicer mixer. The defibration time is set to 10 minutes.

TABLE 1

| | Weight ratio with respect to |
|---|---|
| Material | cellulose |
| phenylboronic acid | 74% |
| ethanol | 900% |
| water | 900% |
| tetramethylammonium hydroxide | adjusted so as to give a pH of |
| | 8.5 or more |

### Example 2

### Production of Cellulose Fiber

Example 2 is different from Example 1 in the composition, the compositional ratio, and the pH of the reaction solution. In the reaction solution of Example 2, a solution obtained by adding phenylboronic acid, ethanol, dimethylethylamine, and tetramethylammonium hydroxide to the aqueous dispersion liquid of KP subjected to the primary defibrating step is used as the reaction solution. The other conditions are the same as in Example 1. The compositional ratio of the reaction solution of Example 2 is shown in Table 2.

TABLE 2

| | Weight ratio with respect to |
|---|---|
| Material | cellulose |
| phenylboronic acid | 74% |
| ethanol | 900% |
| water | 900% |
| dimethylethylamine | 440% |
| tetramethylammonium hydroxide | adjusted so as to give a pH of |
| | 7.4 or more |

### Comparative Example 1

In the method for producing a cellulose fiber of Comparative Example 1, only the primary defibrating step of Example 1 was performed.

### Comparative Example 2

In the method for producing a cellulose fiber of Comparative Example 2, phenylboronic acid was not added to the reaction solution of Example 1, and the steps thereafter were performed.

### Comparative Example 3

In the method for producing a cellulose fiber of Comparative Example 3, phenylboronic acid was not added to the reaction solution of Example 2, and the steps thereafter were performed.

### Comparative Example 4

In the method for producing a cellulose fiber of Comparative Example 4, dimethylethylamine as the reaction aid was not added to the reaction solution of Example 2, and the steps thereafter were performed.

### Evaluation Results

A case where the transmittance of visible light (light in the wavelength range of 400 nm to 600 nm) through the dispersion liquid of water containing the cellulose fiber at a concentration of 0.5 wt % is 80% or more is evaluated as “A (suitable)”, and the other cases are evaluated as “B (not suitable)”. Further, in an SEM (scanning electron microscope) observation, a case where the average fiber diameter is several nanometers to several hundreds of nanometers and the average fiber length is several hundreds of nanometers to several micro meters is evaluated as “A (suitable)”, and the other cases are evaluated as “B (not suitable)”. The evaluation results are shown in Table 3.

TABLE 3

| | Transmittance | SEM observation |
|---|---|---|
| Example 1 | A | A |
| Example 2 | A | A |
| Comparative Example 1 | B | B |
| Comparative Example 2 | B | B |
| Comparative Example 3 | B | B |
| Comparative Example 4 | B | B |

The evaluation results of Examples 1 and 2 and Comparative Examples 1 to 4 shown in Table 3 will be described in detail below. In the case of Examples 1 and 2, both transmittance and SEM observation were evaluated as “A”, however, although there was almost no difference in transmittance, with respect to the SEM observation, the average fiber diameter and the length after the secondary defibrating step were smaller in Example 1 than in Example 2. The difference in the average size of the cellulose fiber is caused because the reaction rate coefficient of the alkaline reaction solution in Example 1 is larger than that of the reaction solution in which the pH was neutral and the reaction aid was added in Example 2, and therefore, the cellulose is modified with phenylboronic acid in a larger amount.

Next, those evaluated as “B” in the evaluation results of Comparative Examples 1 to 4 shown in Table 3 will be described in detail. First, the cellulose fiber of Comparative Example 1 in which only the primary defibrating step was performed was the largest and coarse. Those which yield substantially the same results with respect to the transmittance and the size based on the SEM observation are Comparative Examples 2 and 3 in which phenylboronic acid was not added. The size was slightly smaller in Comparative Example 2 than in Comparative Example 3, and this is considered to be because the alkalinity is higher in Comparative Example 2, and therefore, a larger amount of cellulose is decomposed than in Comparative Example 3.

Then, in comparison between Example 2 and Comparative Example 4, in the case of Example 2 in which the reaction aid was added, the transmittance was high, and also in the observation, a fine cellulose fiber was observed, however, in the case of Comparative Example 4 in which the reaction aid was not added, the dispersion liquid at 0.5 wt % was white cloudy, and also in the SEM observation, the fiber was substantially the same as the fiber obtained by performing only the primary defibrating step. This is considered to be because in the neutral reaction solution, the efficiency of modification with phenylboronic acid greatly varies depending on whether or not the reaction aid (electron donating substance) is present.

Next, an exemplary method for processing a molded material using the cellulose fiber according to the above-mentioned first embodiment or a cellulose fiber obtained by the method for producing a cellulose fiber according to the above-mentioned second or third embodiment will be described below.

### Sheet of Cellulose Fiber

The cellulose fiber modified with phenylboronic acid is dispersed in a solvent, and the viscosity of the dispersion liquid is adjusted with the solvent. The viscosity of the dispersion liquid is preferably 1000 Pa·sec or less. From the viewpoint of ease of film formation, it is more preferred to adjust the viscosity to 1 Pa·sec or less. The viscosity of the dispersion liquid can be appropriately changed according to the film formation method, the thickness of the sheet to be formed, or the like. As the solvent to be used in the dispersion liquid, one solvent or a mixture of a plurality of solvents selected from the solvents to be used for dispersing the composition containing cellulose exemplified for the above-mentioned primary defibrating step can be used. Examples of the film formation process include a spin coating method typified by application, an inkjet method, a dispenser, spray coating, flow coating, relief printing, and intaglio printing. Additional examples thereof include paper making, and a method in which the dispersion liquid is filtered and the deposit on the filter is formed into a sheet. Here, a flow coating method is adopted. In the dispersion liquid, water was used as the solvent, and the viscosity was adjusted to 20000 Pa·sec. The applied dispersion liquid is dried to form a cellulose fiber film. Examples of the drying method include natural drying, ventilation drying, heat drying, vacuum drying, and pressure-heat drying, however, in order to increase the process speed and to reduce warpage or the like after drying, pressure-heat drying was adopted. The drying was performed at a heating temperature of 100° C. with a load of 10 t. After forming the sheet, reduction is performed using an aqueous solution of acetic acid at a pH of 3 so as to return the phenylboronic acid which is the modifying group to a hydroxy group. This sheet is washed with ethanol to remove acetic acid, followed by pressure-heat drying at 100° C. with a load of 10 t, whereby a cellulose fiber sheet is formed.

By doing this, a cellulose fiber sheet having a thickness of about 10 μm with light transmittance is obtained. The cellulose fiber is fine, and therefore, the specific surface area is increased, so that there are a lot of contact points at which the cellulose fibers are entangled, and thus, the sheet has a characteristic that the mechanical strength is very high. Further, since an alkali metal is not contained in the material constituting the cellulose fiber, the sheet can be used in a structural member or the like of an electronic device. Moreover, the cellulose fiber has high crystallinity, and therefore, the gas barrier property of the sheet obtained using the cellulose fiber with high crystallinity is very high, and thus, the sheet can also be used in a food package or the like. In addition, since cellulose represented by the above chemical formula (1) derived from a plant is used, the cellulose fiber has favorable biocompatibility, and therefore can also be used for food, clothing, and medical applications.

### Pellet of Cellulose Fiber Composite Resin

The cellulose fiber of the first embodiment or a cellulose fiber obtained by the method for producing a cellulose fiber according to the second or third embodiment is used as a fiber of a fiber-reinforced resin (FRP: abbreviation of fiber-reinforced plastic). First, the cellulose fiber modified with phenylboronic acid is dried to remove water or the solvent. There are various methods for forming a composite of a resin and a cellulose fiber such as a melt kneading method, a solution mixing method, a method in which a cellulose fiber is mixed with an unpolymerized resin, followed by solidification, and a method in which a melted resin is impregnated into a cellulose fiber, however, here, a melt kneading method in which a dry resin is melted by heating, and the melted resin is mixed with a cellulose fiber is adopted. In the kneading, various kneading methods using a single-screw kneading machine, a twin-screw kneading machine, a role kneading machine, a mixer, or the like can be used, however, here, a single-screw extruding machine is used. As the resin, polyethylene is used. When placing the resin and the cellulose fiber in the device, in order to increase the compatibility between these two materials, a compatibility accelerator can be added. Here, a compatibility accelerator is not used. The melting temperature of the resin is set to 180° C. The diameter of the outlet for the melt-kneaded resin of the extruder is 5 mm. The resin coming out from the outlet was rapidly cooled in a water bath, and cut at an interval of 5 mm after rapid cooling, whereby a pellet having a particle diameter of 5 mm was formed. By using this pellet, molding processing can be performed with an injection molding machine.

The above-mentioned pellet of the cellulose fiber composite resin, polyethylene was used, however, the resin is not particularly limited as long as it is another thermoplastic resin and having a melting temperature of 300° C. or lower. Examples thereof include polyethylene, polypropylene, polybutylene, polybutadiene, polychloroprene, polycaprolactam, polyacetal, polystyrene, polyvinyl chloride, polyvinylidene chloride, polyvinyl acetate, polyurethane, polytetrafluoroethylene, polyvinylidene fluoride, polymethyl methacrylate, polybutyl methacrylate, nylon 6,6, nylon 11, polycarbonate, polyphenylene ether, polyethylene terephthalate, polybutylene terephthalate, polycycloolefin, polyphenylene sulfide, polysulfone, polyethersulfone, polyether ether ketone, and polyarylate, and a homopolymer, a copolymer, a mixture thereof, or the like can be used.

In the above-mentioned pellet of the cellulose fiber composite resin, a compatibility accelerator was not used, however, it is also possible to mix the following compatibility accelerator as an example: maleic acid-modified polyethylene, maleic acid-modified polypropylene, maleic acid-modified styrene, styrene-acrylonitrile-glycidyl methacrylate copolymer, styrene-acrylonitrile maleic anhydride copolymer, or the like.

In the above-mentioned pellet of the cellulose fiber composite resin, a fine cellulose fiber is compounded, and therefore, the strength per unit weight is high, and therefore, the strength per unit volume can be increased, or a necessary strength can be obtained even if the weight of a component is reduced. Further, the cellulose fiber is modified with a hydrophobic phenyl group, and therefore, the compatibility between a hydrophilic cellulose material and a hydrophobic resin material is improved, and thus, the amount of the compatibility accelerator can be reduced.

### Ink Including Cellulose Fiber

An ink can be formed by mixing the cellulose fiber according to the above-mentioned first embodiment or a cellulose fiber obtained by the method for producing a cellulose fiber according to the above-mentioned second or third embodiment with a solution. There are various applications of the ink such as a paint, an adhesive, a printing pigment, a printing dye, a surface coat, surface modification, a water-repellent treatment, and 3D shaping, however, here, an adhesive is adopted. Water is removed from the cellulose fiber by freeze-drying, and a dispersion liquid containing the dried cellulose fiber at 1 wt % is prepared with acetone. Cyclohexanone as a solvent and a vinyl chloride-vinyl acetate copolymer dissolved in methyl ethyl ketone are mixed with the dispersion liquid, whereby an adhesive is formed. This adhesive is applied to an adhesive surface, and dried and solidified by natural drying, heat drying, or the like, whereby a strong adhesion can be obtained. The composition of the adhesive is shown in the following Table 4.

TABLE 4

| Component | Weight (%) |
|---|---|
| cyclohexanone | 50 |
| methyl ethyl ketone | 15 |
| acetone | 14 |
| vinyl chloride-vinyl acetate | 20 |
| copolymer | |
| cellulose fiber | 1 |

In the adhesive as the application of the ink using the above-mentioned cellulose fiber, the adhesive is modified with phenylboronic acid, and therefore, the compatibility with the resin which is the main component of the adhesive is high, and also the strength is high. Further, the adhesive with the above-described cellulose fiber is a fine filler, and therefore, the strength is very high. In addition, the cellulose fiber has high crystallinity, and therefore can exhibit a high gas barrier property. Further, with the cellulose fiber, a high strength can be obtained less expensively than other nylons, carbon, and an aramid fiber.

The method for industrially utilizing the cellulose fiber according to the invention is not limited to the above-mentioned examples. For example, the cellulose fiber can be applied to a lens or a glass substitute structural member by processing the cellulose fiber into a plate material utilizing its transparency. Further, the cellulose fiber can be applied to a building material or an automobile component by processing the cellulose fiber into a rod shape, a columnar shape, or a block shape utilizing the characteristics of light weight and high strength, and can also be applied to an electronic component, a device housing, a device component, or the like formed from a composite resin. In addition, the fine cellulose fiber forms a hydrogen bond network in a solution and exhibits high thixotropy, and therefore can be applied to a metal-containing particle ink with a high viscosity, a ceramic particle-containing ink, a pigment ink, or the like.

The invention is not limited to the above-mentioned embodiments, and appropriate modifications are possible without departing from the gist or idea of the invention readable from the appended claims and the entire specification, and a cellulose fiber thus modified and a method for producing the cellulose fiber are also included in the technical scope of the invention.

The entire disclosure of Japanese Patent Application No. 2017-031826 filed on Feb. 23, 2017 is expressly incorporated by reference herein.

What is claimed is:

1. A cellulose fiber in which hydroxy groups of cellulose represented by the following formula (1) are substituted with a boronate ester group represented by the following formula (2), comprising at least one of:
a type 1 structure in which hydroxy groups of at least one of the unit structures a and b of the same cellulose molecular chain n of the cellulose are substituted with the boronate ester group;
a type 2 structure in which hydroxy groups of both unit structures a and b of the same cellulose molecular chain n of the cellulose are substituted with the boronate ester group; and
a type 3 structure in which hydroxy groups of different cellulose molecular chains n of the cellulose are substituted with the boronate ester group, wherein
carbon to which the hydroxy groups to be substituted with the boronate ester group are bonded is two carbon atoms selected from the carbon atoms at positions 2, 3, and 6 of the unit structures a and b:

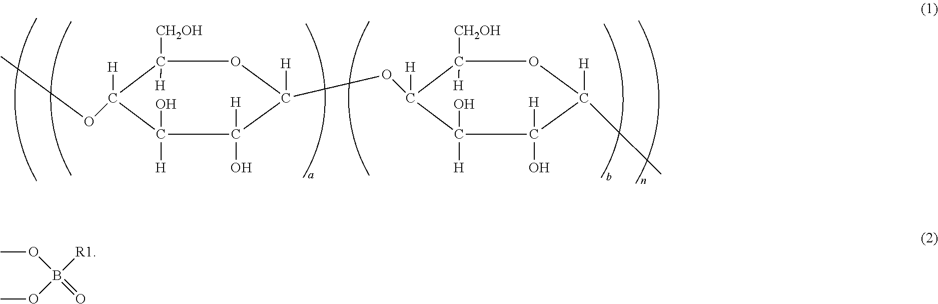

2. The cellulose fiber according to claim 1, wherein R1 of the boronate ester group is a phenyl group.

3. A method for producing a cellulose fiber, comprising a reaction step of performing an esterification reaction of cellulose using a reaction solution which has a neutral to alkaline pH and contains a composition containing the cellulose, a boronic acid compound, and a solvent.

4. The method for producing a cellulose fiber according to claim 3, wherein the boronic acid compound is phenylboronic acid.

5. The method for producing a cellulose fiber according to claim 3, wherein the reaction solution contains an organic alkali which does not contain a metal element.

6. The method for producing a cellulose fiber according to claim 3, wherein the reaction solution contains an electron donating substance.

7. The method for producing a cellulose fiber according to claim 6, wherein the electron donating substance is dimethylethylamine.

8. The method for producing a cellulose fiber according to claim 6, wherein the electron donating substance is contained in the reaction solution when the reaction solution has a pH of 7 or more.

9. The method for producing a cellulose fiber according to claim 6, wherein the electron donating substance is not contained in the reaction solution when the reaction solution has a pH of 8.5 or more.

10. The method for producing a cellulose fiber according to claim 3, wherein the method includes a purification step of removing an unreacted material after the reaction step.

11. The method for producing a cellulose fiber according to claim 3, wherein the method includes a defibrating step of defibrating the composition containing cellulose in advance before the reaction step.

12. The method for producing a cellulose fiber according to claim 3, wherein the method includes a defibrating step of defibrating the composition containing cellulose after the reaction step.

13. The method for producing a cellulose fiber according to claim 10, wherein the method includes a primary defibrating step of defibrating the composition containing cellulose in advance before the reaction step and a secondary defibrating step which is performed after the purification step.

14. The method for producing a cellulose fiber according to claim 3, wherein the method further includes a reducing step of reducing the cellulose modified with the boronic acid compound in the reaction step so as to convert the modifying group into a hydroxy group.

15. The method for producing a cellulose fiber according to claim 14, wherein in the reducing step, the pH of the reaction solution after the reaction step or after the purification step is adjusted to less than 7.

16. The method for producing a cellulose fiber according to claim 15, wherein in the reducing step, an organic acid which does not contain a metal element is added to the reaction solution after the reaction step or after the purification step.

17. The method for producing a cellulose fiber according to claim 16, wherein the organic acid is acetic acid.
